(19) United States
(12) Patent Application Publication
(10) Pub. No.: US 2003/0044344 A1
(43) Pub. Date: Mar. 6, 2003

(54) Method for controlling polysulfide production

(76) Inventors: Victor M. Saucedo, Willowbrook, IL (US); Omar Germouni, Chicago, IL (US); Ovidiu Marin, Lisle, IL (US); Meenakshi Sundaram, Burr Ridge, IL (US); Sebastien Corbeil, Darien, IL (US)

Correspondence Address: E. Joseph Gess, BURNS, DOANE, SWECKER & MATHIS, L.L.P., P.O. Box 1404, Alexandria, VA, 22313-1404, US

(21) Appl. No.: 10/119,150

(22) Filed: Apr. 10, 2002

Related U.S. Application Data
(60) Provisional application No. 60/298,106, filed on Jun. 15, 2001.

(51) Int. Cl. C01B 17/34

(52) U.S. Cl. 423/562

(57) ABSTRACT

The present invention deals with the implementation of advanced controllers that are capable of achieving the desired controlling performance in a polysulfide reactor. These controllers are robust enough to counteract process disturbances as they learn continuously from the measurements of the inputs and outputs. The process comprises controlling the residence time, reaction temperature and oxygen partial pressure using an advanced controller, which adjusts the necessary parameters in order to counteract process disturbances.

### CROSS REFERENCE TO RELATED APPLICATIONS

The present application claims priority to U.S. Provisional Application No. 60/298,106, filed on Jun. 15, 2001, the entirety of which is hereby expressly incorporated by reference.

### BACKGROUND OF THE INVENTION

1. Field of the Invention

The present invention relates to controlling the oxidation of sodium sulfide to polysulfides in order to maintain the desired conversion and selectivity. The present invention further relates to a method of controlling polysulfide production for improved ease of scalability.

2. Brief Description of the Related Art

In the conventional Kraft cooking process, two chemicals, namely sodium hydroxide and sodium sulfide, are used to delignify the wood chips. During the course of the reaction, part of the undesired fraction of wood, lignin, is solubilized and removed. However, cellulose and hemicelluloses, which are desirable components, are also attacked. Hence, one of the goals sought during cooking is to protect this fraction in order to achieve a better process yield.

Theoretically, it should be possible to fully retain cellulose and hemicelluloses. The weight contribution of these components varies with each wood species but is usually around 70%. However, in an industrial process, the amount retained is more in the order of 45-50%. Typically, 80% of the lignin, 50% of the hemicelluloses and 10% of the cellulose are removed. The hemicelluloses are easily attacked since they are low molecular weight sugars that are more accessible than crystalline cellulose. The mechanism by which they are removed is called alkaline peeling and occurs at the reducing end group of the polymeric chain.

It is well known that in order to increase the yield in the Kraft cooking process, polysulfides can be introduced in the digester. This prevents the degradation of the polysaccharides and increases the yield for a given lignin content. This concept was first discussed by Haegglund in 1946 (Svensk Papperstidn. 49(9): 191, 1946).

Polysulfides can be generated by various, different means. In one approach, polysulfides are formed by adding elemental sulfur to the white liquor. However, adding elemental sulfur leads to imbalances in the sulfur balance of the chemical recovery cycle. The build up of sulfur will eventually be released to the atmosphere as a sulfur gas emission. For this reason, this approach has very limited industrial interest.

A second approach consists of chemically oxidizing the sodium sulfide present in the white liquor to sodium polysulfides. The resulting polysulfide liquor is known in the art as orange liquor. This method involves several chemical species, but in general, assuming a polysulfide chain length of n=2, the chemical reactions can be written as follows:

2HS⁻+2O₂ [symbol] 2S₂S⁻²+2OH⁻+2H₂O (1)

2S₂S⁻²+4O₂+2OH⁻ [symbol] 3S₂O₃+H₂O (2)

2HS⁻+2O₂ [symbol] S₂O₃⁻²+H₂O (3)

2HS⁻+3O₂ [symbol] 2SO₃⁻²+2H⁺ (4)

2SO₃⁻²+O₂ [symbol] 2SO₄⁻² (5)

Several variations of this oxidative method have been published. In U.S. Pat. No. 3,470,061, Barker discloses a method using inorganic manganese oxides as the oxidant. In this respect, the chemical equation involving polysulfides can be written as:

MnO₂+2Na₂S+H₂₀ O [symbol] MnO+Na₂S₂+2NaOH (6)

Once reduced, the catalyst is reoxidized with air or oxygen after separation from the white liquor according to:

MnO+½O₂ [symbol] MnO₂ (7)

After defining specific operating conditions in a given reactor, proper sensors and actuators are needed to maintain the desired operating conditions. In order to better understand the challenges encountered when trying to control a Polysulfide (PS) reactor, a simplified non-isothermal continuous reactor is analyzed. The process described in FIG. 1 is a simplified version of an actual polysulfide reactor, but it will be used to underline the implications for process control. The most important assumptions are the following:

The reactor behaves as a CSTR,

It is homogeneous (one phase)

There is only one reaction of first order with respect to Na₂S

The reaction is exothermic and the heat of reaction is known

The jacket fluid is completely well mixed.

The reaction rate is independent of temperature

The inlet flowrate, F₀, has an inlet concentration of Na₂S, Cₐₒ at temperature Tₒ. The outlet flowrate F has a concentration C_{A}, and a temperature T. The reactor temperature is influenced by the fluid flowing through a jacket at a flow rate Fj, and inlet temperature Tjₒ. The dynamic modeling of such a simplified system is very well known in the art of modeling chemical processes. This type of model is called fundamental or first-principle model because it uses mass and energy balances along with thermodynamic and kinetic principles.

There are several factors that make this simple model depart from reality (catalysis effects, if any, heterogeneous character when supplying oxygen, mass and heat transfer limitations, etc.), but it is yet a good example to show the complexity of the problem from the process control point of view. To make this point clear only one equation is analyzed. From the dynamic heat transfer equation of the reactor, the following fundamental model is derived

$$ρ \frac{ⅆ ( Vh )}{ⅆ t} = ρ ( {F}_{o} {h}_{o} - Fh ) - λ V {r}_{{C}_{A}} - UA ( T - {T}_{j} ) \qquad ( 8 )$$

where h is the enthalpy and is equal to CpT, the heat of reaction is represented by λ, and the rate of reaction by r_{C}_{_{A}}. This is a nonlinear equation just considering that the outlet flow F is time varying or time dependent. In order to find the typical control parameters that are used to represent the dynamic system (gain, time constant and time delay), one needs to perform a linearization on the fundamental model equation. Linearizing the equation using Taylor's expansion, and then applying the Laplace transform and rearranging, the expression of how the reactor temperature is influenced by the jacket temperature alone is,

$$T ( s ) = \frac{K}{τ s + 1} {T}_{j} ( s ) , \qquad ( 9 )$$

where,

$$K = \frac{UA}{ρ {C}_{p} F * + UA} , \text{and} τ = \frac{ρ {VC}_{p}}{ρ {C}_{p} F * + UA} \qquad ( 10 )$$

It is very important to see from Equations (9) and (10) that the gain of the process, K, and the process time constant, r, depend on the volume and heat transfer characteristics (UA). F* is constant reactor flow defined for a specific operating condition. As can be seen, the temperature dynamics varies depending on several design and operational parameters.

The most classical controller used in industry by far is the PID (Proportional-Integral-Derivative). This controller can be tuned either empirically by experts or more systematically by means of process analysis. When tuned empirically, the expert varies the controller parameters and observes the process response until it performs satisfactorily. This method can take several minutes or hours depending on the process time response and the expert's skills. The advantage of this procedure is that no model is necessary. If the tuning is to be made more rigorously, an approximate dynamic process model is required, such as Equation (9). If the process model is available, the parameters of the PID controller can be calculated by different methods found in the literature. For example, see W. L. Luyben, Process Modeling, Simulation and Control for Chemical Engineers, McGraw Hill, New York (1986), and, D. Seborg et al., Process Dynamics and Control, Wiley Series in Chemical Engineering, 1989. The advantage of this method is that the controller parameters can be available before any test is made, and no time is lost for testing or disturbing the plant. The main disadvantage of this methodology is that a reliable model is necessary. If the process model is poor, then the controller tune up will suffer in performance. In the example shown above, Equation (9) was obtained by a considerable simplification of the real process. This simplification was made in order to obtain a feasible model. It is difficult to find accurate and complete dynamic fundamental models for the polysulfide process. Therefore, the lack of reliable and accurate models is one disadvantage for applying this technique properly.

A third method for tuning a PID controller uses the combination of the two methods explained above. This method is based on the process model identification. The process identification requires performing at least one experiment (usually a step response), analyzing the data, and then building the mathematical model. This model is called identification model, and is built using the information from observed inputs and outputs. This model is not fundamental anymore, but fits the behavior of the process at the conditions where the experiments are performed and it normally has the same form as Equation (9). Once the model is available the controller tune up is then performed as indicated in the second method. This technique is very popular, and is implemented in several of the commercial control software products. The amount of experimentation in the plant (and therefore the time when the plant is disturbed) when using this method is small, and the accurate model of the plant using fundamental models is not necessary. However, it requires some knowledge to implement the methodology, and it may lead to sub-optimal tuning for interactive multivariable process. This approach leads to obtaining a model, usually first order, linear and time invariant as Equation (9). In most cases, this is just an approximation for a specific operating condition at a specific time. Therefore, it will suffer when the operating conditions or new reactor implementations need change.

When process disturbances occur, PID controllers tend to have problems since processes exhibit behaviors not modeled before or not considered during tuning. If the disturbances are persistent, then a PID controller is destined to show a poor performance. Furthermore, it is common for processes to change with time and retuning of PID controllers is a general practice. This requires either the expert to disturb the process in one way or another, which translates in more time to bring the process into the desired conditions and time that the process does not deliver the correct product quality. A similar problem is faced every time the technology is implemented in a different reactor. Even though all reactors may be used for polysulfide production, thermal efficiencies, heat transfer areas, available input flowrate characteristics, etc., may be different from one another, thus the complete controller tuning procedure is necessary. Although the controller parameter values may share some similarity, an optimally tuned controller requires some tuning work when transferring from one process to another. Equation (10) shows that the process dynamics depends on several process parameters, and when scaling to another reactor, a new controller tuning procedure is required.

One additional drawback that PID controllers suffer from is that they perform poorly when there are process interactions. If one variable to be controlled is changed and this affects one or more variables, then the controllers will need more retuning. Moreover, controller tuning of the processes with interaction is more time consuming.

### SUMMARY OF THE INVENTION

The present invention deals with the implementation of advanced controllers that are capable of achieving the desired controlling performance in a polysulfide reactor. These controllers are robust enough to counteract process disturbances as they learn continuously from the measurements of the inputs and outputs. A variety of adaptive controllers are available that have different degrees of easiness in implementation. All of them reduce downtime because little or no experimentation is needed. No expert is needed and no fundamental model is required. Moreover, the controllers can be transferred to other reactors with no change, even though there are process differences, as they do not require any fundamental model of the process.

More specifically, the production of polysulfides (PS) can be carried out by the oxidation of sodium sulfide or hydrosulfide in continuous reactors. Depending on the process design, this technology requires maintaining a specific temperature, residence time and oxygen partial pressure. The main reaction is exothermic and the use of enriched oxygen streams makes the heat evolution even higher. Disturbances in the volume or inlet conditions will affect the process. A disturbance is any unwanted change in the process, normally unknown and unexpected, that drives the process away from the set point conditions. An advanced controller compensates for any disturbance in the reactor, compensates for temperature changes due to volume changes, and needs no re-tuning when transferred to another reactor for polysulfide production, since they are adaptive. These controllers make scalability easier to achieve by minimizing the time spent for tuning controllers and process upsets. In essence, the present invention has discovered that the efficiency of a polysulfide reactor depends on operating at the right temperature, residence time and oxygen partial pressure, and that those conditions can be maintained despite any disturbances that can occur in the process, e.g., input concentration, temperature or flowrate changes, by implementing an advanced controller.

### BRIEF DESCRIPTION OF THE FIGURES OF THE DRAWING

FIG. 1 is a simplified schematic diagram of a polysulfide production;

FIG. 2 is a control schematic of a real polysulfide production reactor

FIG. 3 is the process control block diagram

FIG. 4 is the diagram of the model based adaptive controller

FIG. 5 is a diagram of the adaptive controller using input-output models

FIG. 6 is a smart controller using input-output data

FIG. 7 MFA performance on temperature control under set point change using default controller settings.

FIG. 8 MFA performance to input flow rate changes.

FIG. 9 Temperature control using MFA controller and process parameters.

FIG. 10 Temperature response to step changes in jacket flow rates.

FIG. 11 PI controller response to temperature step change (τᵢ=1).

FIG. 12 PI controller response to a change in the outlet flow (τᵢ=1).

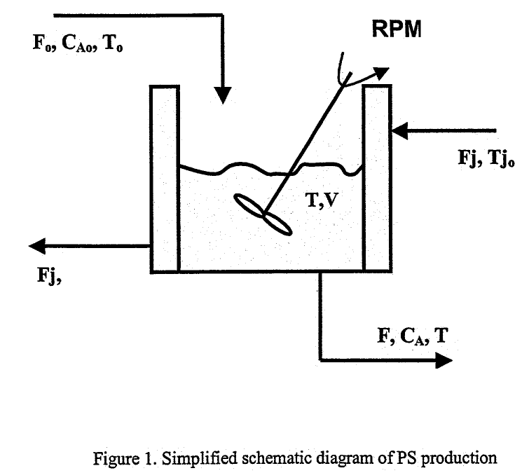

### DETAILED DESCRIPTION OF THE PREFERRED EMBODIMENTS

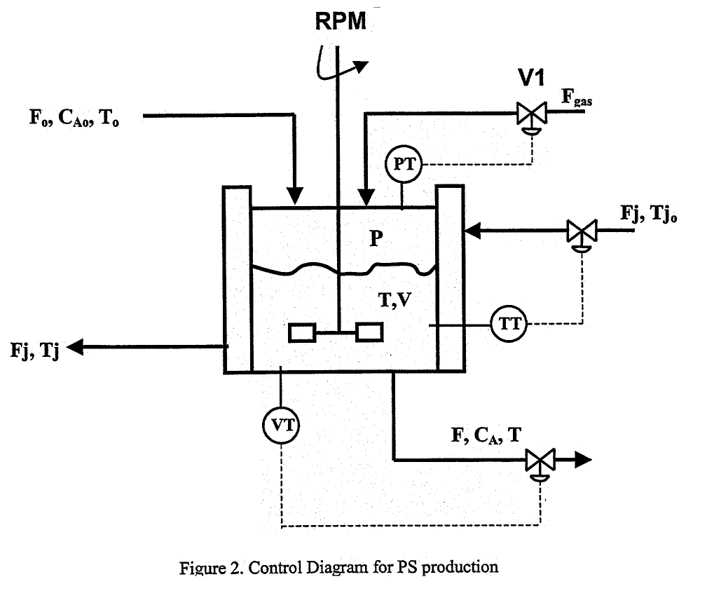

The three most important variables that need to be controlled in order to maintain the desired polysulfide conversion and selectivity are the residence time (ratio of reactor flow rate to reactor volume), the reactor temperature, and oxygen partial pressure. The residence time is controlled varying the liquor flow rates in order to keep a constant volume. The reactor temperature is normally controlled with an indirect cooling flow that passes through a coil or a jacket. The partial pressure is controlled by either controlling a relief valve opening in the reactor headspace, or by varying the oxygen feed flow rate. In industrial situations, it is more common to use a continuous reactor. A general schematic or control diagram is shown in FIG. 2.

Comparing the reactor of FIG. 2 to the ideal CSTR presented earlier, the following differences are encountered:

The reactor may not be an ideal CSTR (mixing may not be perfect)

It is a three-phase system (gas-liquid-solid)

The rates of reaction are unknown

The reactions are highly exothermic

Temperature gradients in the jacket exist

Reaction rates are temperature dependent.

The inlet flowrate, Fₒ, has an inlet concentration of Na₂S, C_{Ao}, at temperature Tₒ. The outlet flowrate F has a concentration C_{A}, and a temperature T. The reactor temperature is influenced by the fluid flowing through a jacket at a flow rate Fj, and inlet temperature Tjₒ. Oxygen rich gas, Fₒ, is supplied to the reactor and pressure P, is held. The temperature and pressure in the reactor determine the solubility of oxygen in the liquor and affect the overall chemical efficiency and selectivity.

It is the aim of the present invention to provide a methodology to adaptively control and easily scale up the control performance for the production of polysulfide from the oxidation of sodium sulfide for a Kraft white liquor.

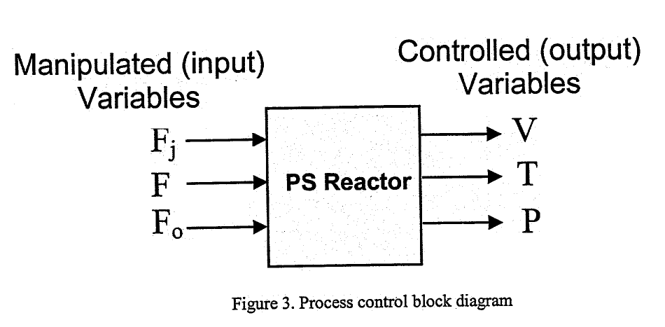

The selectivity and efficiency of a polysulfide reaction is achieved by controlling the reactor temperature, T, its volume (residence time), and the pressure P, in the reactor. These are the controlled or output variables. The preferred manipulated or input variables can be the jacket feed flow rate, Fj, and either the input or output reactor flow, Fₒ or F, respectively, and the oxygen flow rate, F_{gas}, with valve V1. FIG. 3 shows the block representation of a polysulfide process, wherein the chosen manipulated or input variables are Fj, and Fₒ or F, as well as F_{gas}.

This is a Multi-Input Multi-Output (MIMO) system. The main interaction between the inputs and outputs occurs mainly by changing the feed F. As F changes, the volume in the reactor changes which at the same time affects the heat transfer area for a specific jacket flowrate, hence the temperature in the reactor, T, also changes. As the volume changes, the headspace volume changes as well, which makes the pressure change.

Due to the complexity of the process, the interactions between the variables and the difficulty to implement classical PID controllers, multivariable advanced controllers are proposed in this invention. An advanced controller is that which provides improved process control beyond what can be obtained with conventional PID controllers. See, “Process Dynamics and Control”, D. Seborg et al., Wiley Series in Chemical Engineering, 1989, which is hereby incorporated by reference. Advanced controllers are more robust and suitable for complex processes as they can react faster and recover from process disturbances and changes continuously. If no intervention by an operator is needed, as these controllers tune themselves based on the knowledge they have and the information they continuously receive, then these advanced controllers become adaptive controllers. If the advanced controller uses a fundamental process model as additional information, then the controller is called model dependent.

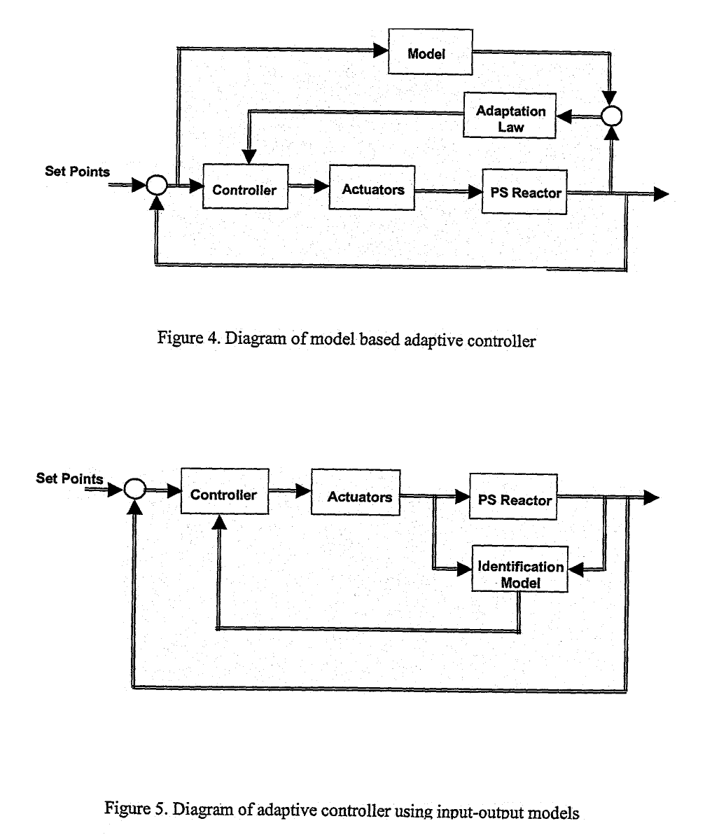

If a reliable fundamental dynamic model of the real system is known, advanced controllers such as feedback linearized controllers, cascade controllers, cancellation controllers, deadbeat controllers, some type of norm controllers (H₂ or H_{∞}), sliding controllers or any form of Model Predictive Control (MPC) can be designed. All these controllers can perform in adaptive mode to compensate for process changes or model mismatches. FIG. 4 shows the general diagram of a model based adaptive controller. The thick arrows in FIG. 4 are used to indicate that the system can be either single variable or multivariable. The model is used as a reference and the difference between the model and the actual plant is used to tune (optimize) the controller performance.

If the fundamental process model is not-known, a different type of advanced controller can be designed. These controllers can use input-output or data driven models built with input-output data, or can be extracted from previous operator experiences. These controllers are called (fundamental) model independent. The information is used to predict the behavior of the process and to adapt the controller continuously. The model independent controllers that use previous operator experiences are called knowledge based controllers and they can be fuzzy controllers or expert systems, to name a few. FIG. 5 shows a general diagram of an advanced controller using input-output models. Next, a more detailed description of adaptive input-output models is given.

If the process outputs or controlled variables (T, P, V) at a given sample interval k are denoted by yₖ, and the manipulated variables or inputs (F, Fj, Fo) are denoted by yₖ, then an input-output model is described as

yₖ=f(yₖ₋₁,yₖ₋₂, . . . ,uₖ₋₁,uₖ₋₂, . . . ) (11)

This model describes the behavior of the system outputs yₖ, based on the behavior of inputs and outputs in the previous time intervals. The function f defines the type of relationship between the inputs and outputs. This relationship can be linear or nonlinear, can have different structures or forms, and can be defined by the engineer familiar in the art of process control. The function f is completely defined by the structure and by the values of its parameters. The procedure to find the values of these parameters is known as systems identification.

The simplest model structure for an input output model corresponds to a linear system that depends on the past inputs alone. This can be written as: Yₖ=a₁uₖ₋₁+a₂uₖ₋₂ + . . . +aₙuₖ₋ₙ (12 )

Equation (12) is known as an ARX (Autoregressive with Exogenous input) model of order n. The set of parameters φ is then defined as:

φ={a₁,a₂, . . . aₙ} (13)

In order to obtain the set of parameters φ, it is common to perform a series of step changes, typically a test known as Pseudo Random Binary Sequence (PRBS). This allows obtaining the interactions between the inputs and outputs. The parameters are normally found by performing a Least Squares (LS). The form of the model f, the identification test and the parameter estimation complete the procedure to find the input output model. The model f can be generalized to ARMAX model (Autoregressive Moving Average with Exogenous input), or its nonlinear versions NARX or NARMAX. For these models, the same LS algorithm is used to identify the parameters. The principles of all these techniques can be found in the literature (e.g., Isermann, R. et. al., 1992, Ljung, L. 1987).

Another nonlinear model form fthat conforms Equation (11) is that of Neural Networks (NN), which can be described generally as

yₖ=ΣwᵢS(uₖ₋₁,uₖ₋₂, . . . ,uₖ₋₃)+Iₖ (14)

where S is a nonlinear function that describes the neuron behavior and is usually defined with the sigmoid function

$$S = \frac{1}{1 + {ⅇ}^{- cx}} \qquad ( 15 )$$

The weights and parameters wᵢ and Iₖ are estimated with nonlinear programming based methods such as back propagation. Other neuron functions and estimation methods are common in the literature (e.g., Kosko, B., 1992).

Once the input output model has been identified, the next step is to design an appropriate controller. An adaptive controller is proposed in this invention. An adaptive controller adjusts its behavior to the changing properties of the controlled process and their signals (e.g., Isermann, R., 1992). A wide variety of linear and nonlinear controllers exist that are able to adjust their behavior as the plant changes. All linear and nonlinear adaptive feedback controllers using input output data are implemented following the general control scheme shown in FIG. 5.

The general adaptive control equation is defined as:

u ₖ=g(eₖ, f(yₖ₋₁,yₖ₋₂, . . . ,uₖ₋₁,uₖ₋₂, . . . )) (16)

where eₖ is the error between the set points, yₛₚ, and the current plant outputs, yₖ,

eₖ=yₛₚ−yₖ (17)

As described in FIG. 5, the set points are compared with the plant output to calculate the error eₖ. This error is the input to the adaptive controller, which also uses the input output model f to generate the input uₖ to the plant. There are two features that are needed in order to have an adaptive controller. First, the controller must be capable of using the information of the input output model to adjust itself, as described by Equation (16). Second, the input output model should have the capacity to change when the plant changes. It was discussed above that an identification procedure is used to completely define the input output model. However, a simple extension of the identification procedure is needed in order for the input output model to continue changing the parameter values during the closed loop control, as shown in FIG. 5, in case the plant changes due to some disturbances or plant degradation. FIG. 5, shows the block of Identification Model to be using the inputs and outputs of the plant to continuously update the input output model. One algorithm that is well known in the control engineering community is that of Recursive Least Squares (RLS) (Isermann, R. et. al., 1992, Ljung, L. 1987). The RLS method updates the values of the parameter set φ, Equation (13), for every new input and output data. The model structure or form of the plant given by function f in Equation (11) remains the same all the time. Only the values of its parameters are updated in the RLS algorithm. The linear controllers that can be used in the adaptive form with RLS algorithm are the pole placement of the general linear controller, deadbeat controller, predictor controller, minimum variance controller and generalized predictive controller. The definition of each one of these controllers should be familiar for engineers in the art of process control (Isermann, R. et. al., 1992). Another advanced control strategy that uses input-output data is that of statistical process control.

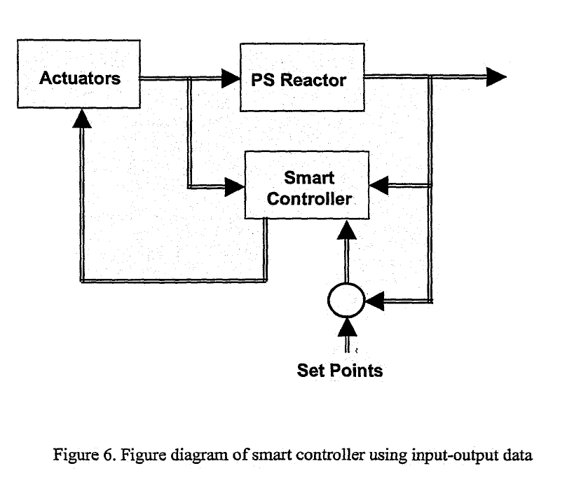

A smart Model-Free adaptive (MFA) controller uses input-output data to identify the parameters of a neural network and will adjust its parameters in real time to generate a control action that minimizes the errors between the measured variables and the set points. Thus, no knowledge of the process model is required. All PS reactors to be scaled will have common qualitative characteristics such as specific heat of reactions, solubilities, mass and reaction mechanisms that come from using the same technology. A limited tuning of the controller is needed only once and accounts for the degree of interaction between the controlled variables (temperature and volume) with respect to the manipulated variables, outlet flow rate and heat removed. Once this tuning is defined for a given PS reactor, the smart controller will adapt itself to another PS reactor as input and output data are collected. The general block diagram of these actions is shown in FIG. 6. It can be seen that no block diagram is needed to represent the process model.

The smart controller still keeps the information of the degree of interaction between the different inputs and outputs, which are expected to have minimum variations. The new output response from another PS reactor based on different dimensions, heat and mass transfer characteristics are learned by the smart controller as the new process starts running. The smart controller will not need any human intervention to track the desired set points.

In the case of process disturbances, the smart controller is capable of learning from the corresponding input and output data so that these disturbances cause minimum effects in the process. If process performance changes as a function of time because of any alteration of just aging effects, the smart controller will again adapt based on the inputs and outputs and the desired set points will be tracked with no tuning and no loss in performance or quality of the product.

Without losing generality, the differences in implementation and performance between a MFA controller and a PID controller are compared with simulation results of a PS reactor. The continuous PS reactor is modeled with unsteady state mass and energy balances described next.

Making reference to FIG. 2, the overall unsteady state mass balance in the inlet and outlet flows assuming equal densities is:

$$\frac{ⅆ V}{ⅆ t} = {F}_{o} - F \qquad ( 18 )$$

The sodium sulfide (Na₂S) is consumed to produce polysulfide (Na₂S₂) and sodium sulfite (Na₂SO₃). The mass balance for these components are expressed as:

$$\frac{ⅆ S}{ⅆ t} = ( {F}_{o} \cdot {S}_{io} - F \cdot {S}_{i} + r \cdot V - {S}_{i} \cdot \frac{ⅆ V}{ⅆ t} ) / V \qquad ( 19 )$$

where Sᵢ is the concentration of any of the sulfur compounds, and r is the combined mass transfer, k_{L}a, and reaction kinetics in the form of

$$r = \pm {O}_{2}^{*} \cdot ( \frac{{k}_{2} \cdot {S}_{i}^{xi}}{1 + ( \frac{{k}_{2} \cdot {S}_{i}^{xi}}{{k}_{L} a} )} ) \qquad ( 20 )$$

The reaction kinetics can have two kinetic terms depending if the sulfur compound is consumed/produced in two different reactions, as indicated in Equations (1-5). Furthermore, Equation (20) can be simplified for some components when the reaction is mass transfer or kinetic limited. The definitions of all the different parameters are listed at the end of this report.

There are two systems that need to be analyzed when it comes to study the temperature variation in the reactor. One of them is the reactor itself, and secondly, the cooling jacket that removes heat from the reactor. The reactor temperature is affected by the enthalpies of the flows, the heats of reaction, and the heat removed by the cooling jacket:

$$\frac{ⅆ T}{ⅆ t} = \frac{\begin{matrix}{ρ}_{o} ( {F}_{o} \cdot {Cp}_{o} \cdot {T}_{o} - F \cdot Cp \cdot T ) + \frac{{r}_{1} \cdot {λ}_{1} \cdot V}{32} + \frac{{r}_{4} \cdot {λ}_{2} \cdot V}{32} - \\ U \cdot A \cdot ( T - {T}_{j} ) - {ρ}_{o} \cdot Cp \cdot T \cdot \frac{ⅆ V}{ⅆ t}\end{matrix}}{{ρ}_{o} \cdot Cp \cdot V} \qquad ( 21 )$$

At this point, a few remarks are worth mentioning. The reaction kinetics are given in units of grams/min, and the heats of reaction are in cal/mol, therefore, the molecular weight of oxygen is used to make the quantities dimensionally correct. There are two terms that represent the heat generated by reactions. The first, heat of reaction, λ₁, corresponds to the production of polysulfide, while the second, λ₂, corresponds to the conversion of thiosulfate from sodium sulfide.

The energy balance around the cooling jacket assumes that the cooling fluid (water) is completely well mixed inside the jacket, so there are no temperature gradients in any direction. The cooling jacket temperature, Tⱼ, is modeled as:

$$\frac{ⅆ {T}_{j}}{ⅆ t} = \frac{{F}_{j} \cdot {ρ}_{{j}_{o}} ( {Cp}_{{j}_{o}} \cdot {T}_{{j}_{o}} - {Cp}_{j} \cdot {T}_{j} ) + U \cdot A \cdot ( T - {T}_{j} )}{{ρ}_{{j}_{o}} \cdot {Cp}_{j} \cdot {V}_{j}} \qquad ( 22 )$$

The simulations include the solution of the set of ODEs (Ordinary Differential Equations). The nominal values used in the simulations are presented in the following table:

| Variable | Value | | Variable | Value | |
|---|---|---|---|---|---|
| V | 0-580 | L | ρ | 1000 | g/L |
| F, Fₒ | 0-250 | L/min | Tₒ | 60-80° | C. |
| Fⱼ | 0-100 | L/min | Cp = Cpₒ | 1 | cal/gr ° C. |
| Na2So | 15.6 | g/L as | λ₁ | 44.7 × 10³ | cal/mol Nas₂S |
| | | Sulfur | | | |
| k2 | 1.7 × 10³ | 1/min | λ₂ | 121 × 10³ | cal/mol Na₂S |
| x2 | 1.8 | | U | 3.98 × 10⁴ | cal/mol Na₂S |
| k3 | 8.28 × 10⁴ | 1/min | A | 1.98 | m² |
| x3 | 0 | | Tⱼₒ | 20° | C. |
| RPM | 240 | | Vⱼ | 28.14 | L |
| P | 14.7 | psia | D | 0.9 | m |
| σ (surface | 72.75 | g/s² | Da | 0.36 | m |
| tension) | | | | | |
| μ (w. | 1 | cp | Qv | 0.05 | m³/sec |
| viscosity) | | | | | |
| T | 60-85° | C. | | | |

The closed loop simulations assumed a constant inlet flow temperature, T₀, of 80° C., and a constant inlet jacket temperature, Tⱼₒ, of 20° C. The reactor temperature control is tested making a step change from 80 to 75° C. Previous simulations indicated that in order to control the temperature at 70° C., a higher cooling capacity or a lower inlet flow operating enthalpy was needed. The volume control was tested with a feed step change, as it was assumed that it was more desirable to operate at the same volume all the time.

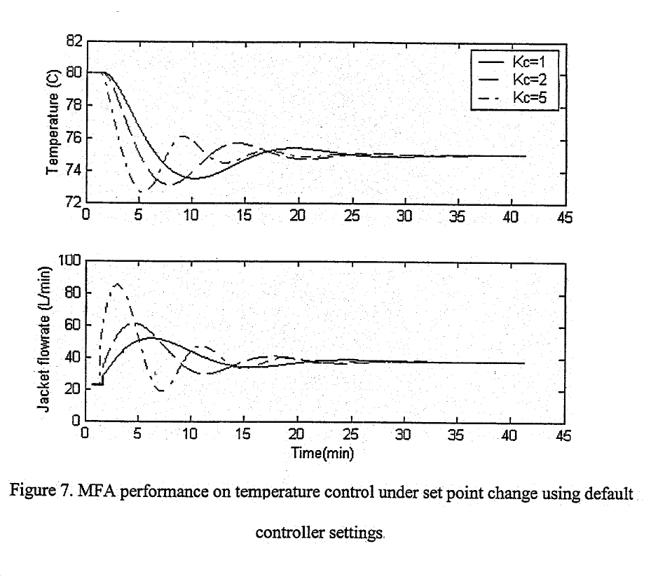

FIG. 7 shows the response of temperature with the MFA controller. The MFA controller has few parameters to set up. One of them is the type of controller based on the system dynamics. If the system is suspected not to have large time delays and is 2×2, then a Standard MFA is recommended. Once this controller is selected, the time delay of 20 seconds (default value) is also chosen. This selection is representative of the action taken when there is no knowledge of the process. Next, the relationships between inputs and outputs have to be defined in order for the controller to know in which direction to act. Table I shows the relationship for the PS reactor. It can be seen that there is some coupling between the reactor temperature and the feed flow, since the variation of flow rates makes the volume to change and so the transfer area varies as well. On the other hand, the volume is unaffected by the jacket flow rate.

TABLE I
Input and output acting relationships

| | T | V |
|---|---|---|
| Fj | Inverse | N/A |
| F | Direct | Inverse |

Finally, the MFA controller gain has to be defined. The higher the value, the more active the control response is. FIG. 7 shows the temperature response for three different gain values. All the control responses reach the new stability value in approximately 25 minutes. The controller with the highest gain produces the largest overshoot, but the response may not be critical for the PS reactor. Nevertheless, the jacket flow rate increases almost 50% when the high gain is used, and this may be a design constraint in the real plant.

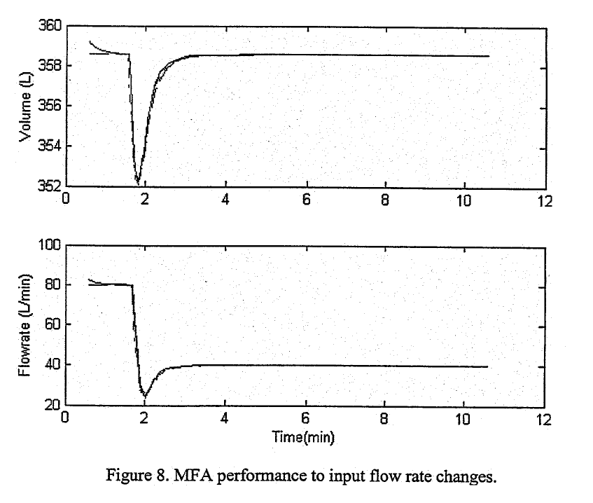

The response of the volume control against feed changes is shown in FIG. 8. It was not necessary to change the corresponding control gain for this variable. The default control gain of 1 (one) resulted in acceptable response time of a few minutes and a volume upset less than 2%. The different responses in the volume control correspond to the different control gains used in the temperature controller, which show no effect on the volume control performance.

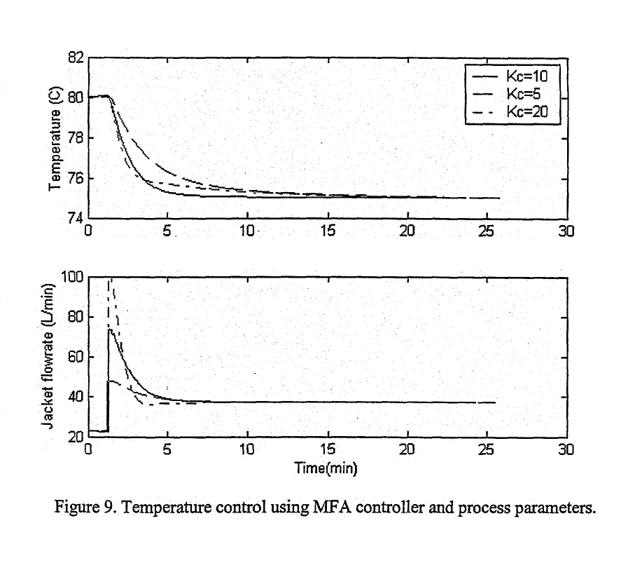

Additional simulations with the MFA controller were performed assuming that the process time constant was known. Assuming that the real time constant is 3.5 min (later on will be shown why this number is used), then the process responses are shown in FIG. 9. The suggested control gain, Kc, is such that Kc*Kp≈1. As it will be shown later on, the process gain for temperature control is approximately 0.21, then Kc should be around 4.7.

Using a closer to the real time constant makes the MFA controller to respond faster and reduce overshooting. The faster response in the temperature reduces the time to reach quasi-steady state by almost 50% compared to when using unknown time constant MFA. It is shown with these results that the knowledge of process time constant can have a big impact in the performance of the MFA controller. The results and settings for volume control were unchanged.

It was also noticed that the controller is not as stable as expected for poorly estimated process time constant values, especially highly underestimated values of time constant.

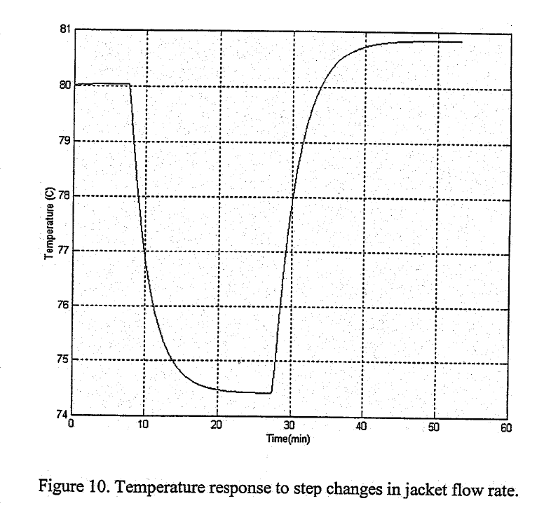

A different option was that of performing manual step changes and observing its response. FIG. 10 shows a couple of responses in the reactor temperature, T, based on step changes in the jacket flow rate Fj. By analyzing these responses, it can be observed that the temperature response can be approximated to a first order system with a gain of 0.214, and a time constant of 3.22 min. The gain is estimated as the ratio of the total temperature change divided by the input change. The time constant is calculated as the time in the response that it takes to reach 63.2% of the maximum response. These results were used as reference to improve the tuning of the MFA controller in the previous section.

The stability, analysis and the tuning of the PI controllers was achieved using the Root Locus method. Using a PI controller, the closed loop characteristic equation shows two poles at zero, and the system is stable for all combinations of the controller parameters (gain K_{c} and integral parameters τ₁). However, for small values of τ₁, the system remains close to the imaginary axis and a bigger oscillatory behavior is found. A value of 1 (one) for τ₁ makes the system to be far apart from a strong oscillatory behavior. The higher the gain the faster the temperature response to a step changes. A controller gain of 10 is recommended.

The volume control scheme presented in FIG. 2 uses the output flow as the manipulating variable. This strategy was taken from preliminary studies assuming the feed slow rate is controlled with an independent control loop.

The results presented to this point assume that the output flow rate is varied with a pump. The volume response with this configuration is known to be a pure integrator, which is unstable for step changes. Moreover, the integrator is negative, which leads to problems in tuning a PI controller, since the system remains unstable. The volume control becomes stable by either changing the sign of the controller gain or using the input flow rate to control the volume.

If the reactor head is used instead of the withdrawal pump, the volume control dynamics becomes a stable first order process, which is easier to control, however, this can lead to high time constants (depending on the opening of the outlet valve). Consequently, longer periods to reach steady state may be observed. Therefore, in order to have a fair comparison with the MFA controller implementation, it was decided to change the control approach by using the inlet feed as the manipulating variable, and the outlet flow as the disturbance. This reactor will also have the pure integrator transfer function, but it will be positive, and the PI controller can now be tuned using positive controller gains.

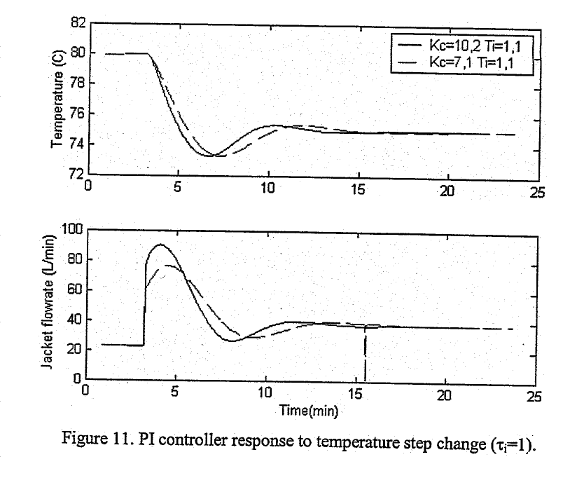

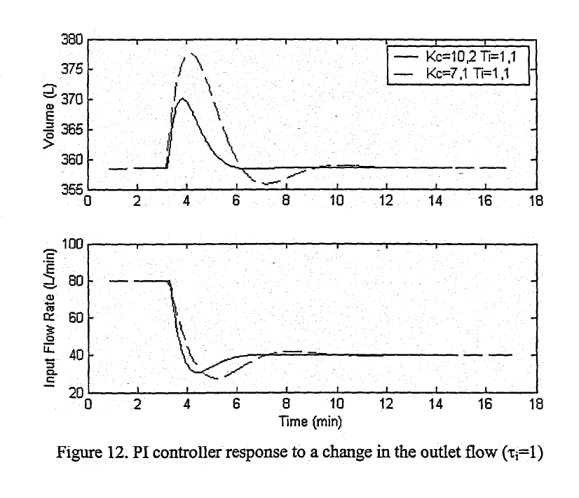

After applying Root Locus analysis, it was found that an integral constant of 1 (one) for the volume controller gives an appropriate response. FIGS. 11 and 12 show the performance of the PI controller for fixed integral constant to 1 (one) and various controller gains. The PI controllers respond to simultaneous temperature step change and flow disturbance, and with the same order of magnitude as with the MFA tests. FIG. 11 shows the performance of the PI controller on the temperature change. It can be seen that the tuning performed results in relatively short stabilization times and little overshooting. However, this is not the case for the PI performance trying to reject the flow disturbance. The PI action takes longer to stabilize compared to the MFA controller and at the same time, the controlled variable has larger errors.

The performance of different controllers can be compared using a series of metrics or indexes. One of the most common indexes is that of Sum of Squared Errors (SSE) defined as the square of the difference between the controlled output response and the desired set point. Table II shows the SSE comparison between the two different controllers using the controller gain that resulted in the smallest SSE. For the sake of completeness, the performance of the MFA controller using the default setting and the “tuned” settings are included.

TABLE II
Smallest SSE's for different controllers

| Variable | Default MFA | Tuned MFA | PI |
|---|---|---|---|
| T | 1.12 × 10³ | 514 | 667 |
| V | 362 | 350 | 3.7 × 10³ |

Although it has been heralded that one of the most important features of the MFA controller is the ability of performing satisfactorily with no previous knowledge of the process, it can be seen in Table II that the SSE for the temperature is much larger that of the PI, which required considerable time for tuning. However, if some information about the process is incorporated into the MFA, then the performance improves greatly and then the MFA performs better than the PI controller. Regarding the volume control, the MFA was able to perform better than the PI using the default controller settings. This could be that the default controller settings (20 seconds) are very close to the real time constant of this process. The PI controller had more problems to recover from the disturbance and so; the SSE's increased substantially.

Another index that could help in comparing the performance of the controllers is the settling time, which is related to the time the process takes to reach and remain relatively close to the final steady state value, which is the desired set point. Table III shows the different settling times for the three different controllers under study.

TABLE III
Settling time (min) for different controllers

| Variable | Default MFA | Tuned MFA | PI |
|---|---|---|---|
| T | 20 | 10 | 12 |
| V | 2 | 2 | 3 |

Again, the default MFA temperature controller does not perform better than the PI controller, which uses the process information. However, when the process time constant is used the settling time for the MFA controller is reduced to half the default MFA result. The tuned MFA is able again to improve the PI controller performance. Regarding volume, the MFA controller is able to reduce the settling time compared to the PI controller, although according to this index, the PI controller performance is considered acceptable.

Throughout the description, a number of different symbols were used in the various equations and Tables discussed. A summary of the symbols and their meaning is as follows:

Nomenclature:

V=Reactor volume

T=Reactor temperature

Fₒ=Reactor inlet flow

F=Reactor outlet flow

Fj=Reactor cooling flow

Na₂Sₒ=Sodium sulfide inlet concentration

k2, x2, x3, x3=kinetic parameters

RPM=Agitation speed in Revolutions per Minute

P=Reactor head pressure

σ=Surface tension

μ=Viscosity

ρ=Density

To=Inflow temperature

Cp, Cₒ=Heat capacities of flows

λ₁, λ₂=Heats of reaction

U=Overall heat transfer coefficient

A=Heat transfer area

Tjₒ=Cooling jacket volume

D=Reactor diameter

Da=Stirrer diameter

Qv=Oxygen flow rate

While the invention has been described with preferred embodiments, it is to be understood that variations and modifications may be resorted to as will be apparent to those skilled in the art. Such variations and modifications are to be considered within the purview and scope of the claims appended hereto.

What is claimed is:

1. A process for the production of polysulfides by oxidizing sodium sulfide in a reactor, with the process comprising controlling the residence time, the reactor temperature and oxygen partial pressure by using an advanced control system which adjusts the parameters necessary to control the residence time, reactor temperature and oxygen partial pressure in real time to generate a control action that reduces the errors between the measured variables and set points.

2. The process of claim 1, wherein the reaction is a continuous reaction.

3. The process of claim 1, wherein information from the inputs and the outputs of the reactor are utilized by the advanced control system to generate a control action.

4. A process using an advanced controller to control variables and product quality during polysulfide production by oxidizing sodium sulfide present in white liquor.

5. The process of claim 1, wherein the residence time is controlled by varying the flow rates in order to keep a constant volume.

6. The process of claim 1, wherein the reactor temperature is controlled by the jacket flow rate.

7. The process of claim 1, wherein the oxygen partial pressure is controlled by oxygen flow.

8. The process of claim 1, wherein the advanced control system comprises an adaptive controller.

9. The process of claim 1, wherein the advanced control system comprises a knowledge based controller.

10. The process of claim 1, wherein the advanced control system comprises a statistical controller.

11. The process of claim 8, wherein the adaptive controller uses a fundamental model.

12. The process of claim 8, wherein the adaptive controller uses an input/output model.
